(19) United States
(12) Patent Application Publication
(10) Pub. No.: US 2026/0167746 A1
(43) Pub. Date: Jun. 18, 2026

(54) STRENGTH-ENHANCED AND TOUGHENED PLASTIC MATERIAL COMPOUNDED WITH SINGLE-CHAIN NANOPARTICLES AND PREPARATION METHOD THEREFOR

(71) Applicant: Jilin University, Changchun (CN)

(72) Inventors: Hujun Qian, Changchun (CN); Lei Zhang, Changchun (CN)

(21) Appl. No.: 19/464,599

(22) Filed: Jan. 30, 2026

(30) Foreign Application Priority Data
Aug. 27, 2025 (CN) 2025112042709

(51) Int. Cl. C08F 2/44; C08F 2/06; C08F 2/38; C08F 4/04; C08F 212/08; C08F 220/14; C08F 220/36; C08K 7/16; C08L 33/10

(52) U.S. Cl. CPC C08F 2/44; C08F 2/06; C08F 2/38; C08F 4/04; C08F 212/08; C08F 220/14; C08F 220/36; C08K 7/16; C08L 33/10

(57) ABSTRACT

A strength-enhanced and toughened plastic material compounded with single-chain nanoparticles and a preparation method therefor are provided, belonging to the technical field of polymer plastics. The strength-enhanced and toughened plastic material includes the following raw materials in parts by weight: 10-20 parts of a polymer monomer, 0.004-0.005 parts of an initiator, 0.05-0.06 parts of a chain transfer agent, 8-12 parts of a solvent, and 0.1-0.2 parts of a functional filler. The preparation method specifically includes the following steps: (1) weighing individual raw materials; (2) uniformly mixing the raw materials, replacing with a nitrogen gas atmosphere, and polymerizing; and (3) reprecipitating, and vacuum drying to obtain the final product.

### CROSS REFERENCE TO RELATED APPLICATIONS

The present disclosure claims the priority to the Chinese patent application with the filing No. 202511204270.9, entitled “STRENGTH-ENHANCED AND TOUGHENED PLASTIC MATERIAL COMPOUNDED WITH SINGLE-CHAIN NANOPARTICLES AND PREPARATION METHOD THEREFOR” and filed on Aug. 27, 2025 with the Chinese Patent Office, the contents of which are incorporated herein by reference in their entirety.

### TECHNICAL FIELD

The present disclosure relates to the technical field of polymer plastics, and more particularly to a strength-enhanced and toughened plastic material compounded with single-chain nanoparticles and a preparation method therefor.

### BACKGROUND ART

It has long been a core challenge in material property optimization to effectively address the issue of “strength-toughness trade-off” in the field of plastic materials. Generally, enhancement of the mechanical strength of plastics often results in a reduction in their toughness, and vice versa.

To address this issue, prior arts often employ approaches such as using inorganic fillers (such as carbon black, silica, clay, etc.) or performing blending modification to achieve strength-enhancing or toughening effects. However, these traditional methods generally have the following limitations: on the one hand, inorganic fillers easily cause compatibility issues with the polymer matrix, resulting in limited improvement in the mechanical properties of the material; and on the other hand, excessive filler addition may affect the processing performance and product quality of the material, even cause embrittlement and thus limit its practical applications. In addition, this technique struggles to achieve synchronous optimization of strength and toughness. Especially against the backdrop of the ever-growing demand for high-performance plastics, the development of modified plastic materials that possess both high strength and high toughness is of important technical significance and holds broad application prospects.

Therefore, the problem that needs to be solved urgently by those skilled in the art is how to balance the strength and toughness of plastic materials.

### SUMMARY

In view of this, the purpose of the present disclosure is to provide a strength-enhanced and toughened plastic material compounded with single-chain nanoparticles and a preparation method therefor, so as to solve the shortcomings of the prior art.

To achieve the above purpose, the present disclosure adopts the following technical solution.

A strength-enhanced and toughened plastic material compounded with single-chain nanoparticles includes the following raw materials in parts by weight: 10-20 parts of a polymer monomer, 0.004-0.005 parts of an initiator, 0.05-0.06 parts of a chain transfer agent, 8-12 parts of a solvent and 0.1-0.2 parts of a functional filler.

Aiming to address the problem that the strength and toughness are difficult to be balanced in prior plastic materials, the present disclosure provides a plastic modification technique and a material system based on the compounding of single-chain nanoparticles (SCNPs). By introducing SCNPs with molecular-scale dispersibility and excellent compatibility into the polymer matrix, the synergistical improvement of properties of the plastic material such as mechanical strength, fracture toughness, and ductility of plastic materials are achieved, thereby overcoming the property trade-off and processing limitations faced by traditional approaches of using inorganic fillers or performing blending modification, and meeting the application requirements for high-property high-reliability plastic materials.

Further, the above-mentioned strength-enhanced and toughened plastic material compounded with single-chain nanoparticles includes the following raw materials in parts by weight: 15 parts of the polymer monomer, 0.00427 parts of the initiator, 0.0525 parts of the chain transfer agent, 10 parts of the solvent, and 0.15 parts of the functional filler.

Further, the above-mentioned polymer monomer has a wide applicability and may be selected from the group consisting of methyl methacrylate, ethyl methacrylate and styrene, and preferably ethyl methacrylate (EMA).

The beneficial effects of adopting the above further lies in that the method of the present disclosure has a strong universality and is applicable to any polymerizable polymer monomers, for example, methyl methacrylate (MMA), ethyl methacrylate (EMA), styrene (ST), etc., and the present disclosure mainly presents the results obtained by using the ethyl methacrylate as the monomer. EMA, as a representative acrylate plastic monomer, helps to demonstrate the universality of the present disclosure.

Further, the above-mentioned initiator is azobisisobutyronitrile (AIBN).

The beneficial effects of adopting the above further lies in that AIBN has a moderate initiation temperature, good controllability, strong applicability to a variety of monomers, high initiation efficiency, and few side reactions.

Further, the above-mentioned chain transfer agent is 4-cyano-4-[(dodecylsulfanylthiocarbonyl)sulfanyl]pentanoic acid (CTA).

The beneficial effects of adopting the above further lies in that through a reversible chain transfer equilibrium, the CTA significantly suppresses the side reaction of bimolecular termination, achieves the controllability of polymerization molecular weight, and reduces the polydispersity index (PDI) to as low as approximately 1.0, which is crucial to the mechanical properties of the plastic material.

Further, the above-mentioned solvent is 1,4-dioxane.

The beneficial effects of adopting the above further lies in that 1,4-dioxane has a moderate boiling point and is safe to operate.

Further, the above-mentioned functional filler is single-chain nanoparticles (SCNPs), with the following structural formula of

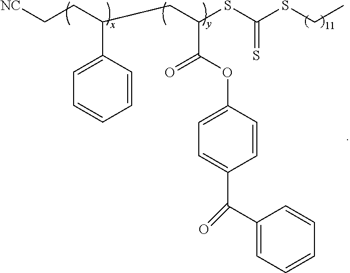

The beneficial effects of adopting the above further lies in that the single-chain nanoparticles, as a new type of polymer-based nanomaterial, have good molecular-scale compatibility, can achieve uniform molecular-level dispersion in polymer matrix, and are less prone to macroscopic phase separation.

A preparation method for a strength-enhanced and toughened plastic material compounded with single-chain nanoparticles specifically includes the following steps of:
(1) weighing individual raw material according to the parts by weight of the above-mentioned strength-enhanced and toughened plastic material compounded with single-chain nanoparticles;
(2) mixing all raw materials uniformly, replacing with a nitrogen gas atmosphere, and polymerizing to obtain a reaction product; and
(3) reprecipitating the reaction product in a poor solvent and vacuum drying to obtain the strength-enhanced and toughened plastic material compounded with single-chain nanoparticles.

Aiming at the property regulation problem faced by plastic materials, the present disclosure proposes a novel technical route based on compounding modification of SCNPs. This method can improve the strength and toughness of plastic materials without significantly sacrificing other properties, and satisfy the application requirements of high-property engineering plastics in fields of automobiles, electronics, packaging, etc.

Further, in the above-mentioned step (2), the time for the replacing is 30 min; and the polymerizing is performed at a temperature of 80° C. for a time of 12 h.

Further, in the above-mentioned step (3), the poor solvent is methanol; and the vacuum drying is performed at a temperature of 70° C. for a time of one week.

It can be seen from the above technical solutions that compared with the prior art, the present disclosure achieves the synergistic optimization of strength and toughness of the plastic material by introducing single-chain nanoparticles (SCNPs) into the plastic matrix, and has the following remarkable technical effects and practical advantages.

1. Synergistic enhancement of strength and toughness: as highly flexible and deformable nanoparticles, SCNPs can be uniformly dispersed in the plastic matrix and promote the synergistic movement between polymer chain segments. This mechanism effectively improves the tensile strength, elongation at break, and impact toughness of the plastic material, significantly outperforms traditional strength-enhanced systems using inorganic fillers, and effectively breaks through the material property bottleneck of “strength-toughness trade-off”.

2. Simultaneous enhancement of flexural strength: the strength-enhanced and toughened plastic material of the present disclosure not only exhibits an outstanding tensile property, but also simultaneously exhibits an excellent mechanical response under flexural loads, and is suitable for engineering plastic application scenarios with high requirements for structural stability and in-use safety.

3. Simple process and strong universality: the modification method adopted in the present disclosure is simple in process and excellent in controllability, and can be compatible with prior polymerization or blending processing procedures, requires no additional complex equipment or high-energy-consumption conditions, is applicable to various general-purpose plastic and engineering plastic systems, and thus has good versatility and industrialization prospects.

4. In summary, the present disclosure discloses a strength-enhanced and toughened plastic material compounded with single-chain nanoparticles (SCNPs) and the preparation method therefor, which are applicable to the optimization of mechanical properties of thermoplastic plastic systems such as polymethyl methacrylate (PMMA), polyethyl methacrylate (PEMA), and polystyrene (PS). In the above, SCNPs are nanoparticles formed by the internal crosslinking of flexible polymer single chains, and can achieve uniform molecular-scale dispersion in the plastic polymer matrix, and thereby significantly improve the toughness and ductility of the material on the basis of enhancing the its overall strength, such that the obtained composite material exhibits excellent tensile strength, fracture toughness, ductility and flexural strength. The strength-enhanced and toughened plastic material of the present disclosure is applicable to various application scenarios with higher requirements for plastic mechanical properties, including but not limited to fields of automotive interior and exterior accessories, electronic product housings, sports equipment, household appliance structural components, high-strength packaging materials, building decoration materials, etc., and has broad industrialization application prospects.

### BRIEF DESCRIPTION OF DRAWINGS

FIG. 1 is a view showing the synthesis route of single-chain nanoparticles;

FIG. 2 is the nuclear magnetic resonance hydrogen spectrum (¹H NMR) of the single-chain nanoparticles;

FIG. 3A shows the tensile stress-strain curves of the samples of Comparative Example 1 and Example 1, and FIG. 3B shows the tensile mechanical property statistic data of the samples of Comparative Example 1 and Example 1;

FIG. 4 shows the three-point bending stress-strain curves of the samples of Comparative Example 1 and Example 1; and

FIG. 5 shows a scanning electron microscopy image of the fracture surface of the sample of Example 1.

### DETAILED DESCRIPTION OF EMBODIMENTS

The technical solutions in the embodiments of the present disclosure will be clearly and completely described below. Obviously, the described embodiments are only some of the embodiments of the present disclosure, not all of the embodiments. Based on the embodiments of the present disclosure, all other embodiments obtained by a person ordinarily skilled in the art without creative work fall within the scope of protection of the present disclosure.

### Example 1

The strength-enhanced and toughened plastic material compounded with single-chain nanoparticles included the following raw materials by weight: ethyl methacrylate (0.13 mol, 15 g), azobisisobutyronitrile (0.026 mmol, 4.27 mg), 4-cyano-4-[(dodecylsulfanylthiocarbonyl)sulfanyl]pentanoic acid (0.13 mmol, 52.5 mg), 1,4-dioxane (10 mL), and single-chain nanoparticles (150 mg, approximately 1 wt % of the system mass).

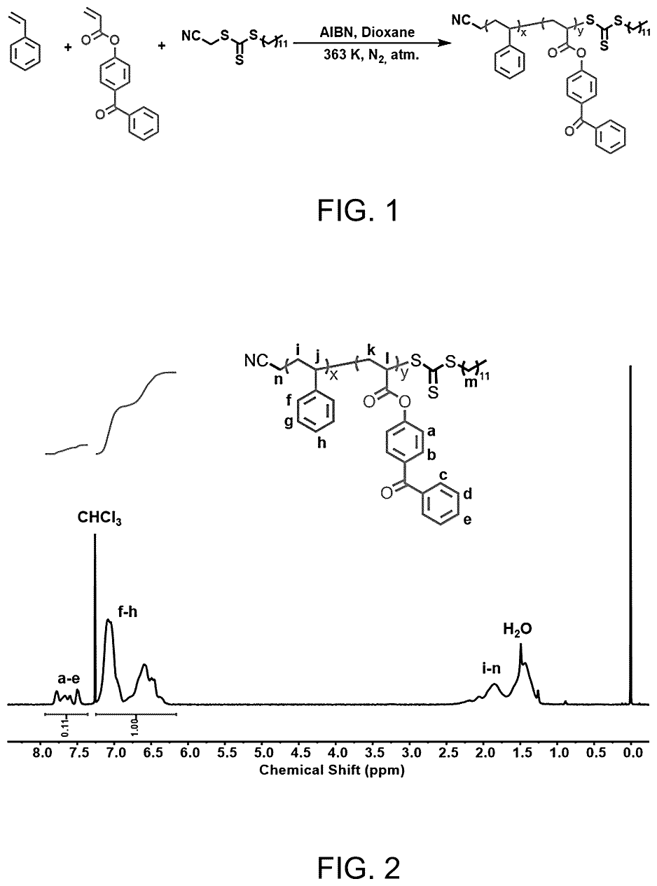

In the above, the synthesis route of the single-chain nanoparticles was as shown in FIG. 1 and included the following steps: mixing the styrene (0.095 mol, 9.9 g), 4-acryloyloxybenzophenone (crosslinking agent, 5 mmol, 1.26 g), azobisisobutyronitrile (0.05 mmol, 8.2 mg), cyanomethyl dodecyl trithiocarbonate (0.25 mmol, 79.4 mg), and 1,4-dioxane (10 mL) uniformly, replacing with a nitrogen gas atmosphere, and performing polymerization reaction at 90° C. for 24 h; and after completion of the reaction, reprecipitating in the poor solvent methanol and vacuum drying at 50° C. for 24 h.

The nuclear magnetic resonance hydrogen spectrum (1H NMR) of the single-chain nanoparticles was as shown in FIG. 2. As can be seen from FIG. 2, the spectral analysis showed that the characteristic peaks of styrene and 4-acryloyloxybenzophenone were both present, confirming that the two had successfully achieved random copolymerization, and the structural unit content of 4-acryloyloxybenzophenone was (0.11/9)/((0.11/9)+(1/5))=5.7%.

The preparation method for the above-mentioned strength-enhanced and toughened plastic material compounded with single-chain nanoparticles specifically included the following steps:
(1) weighing each raw material according to the weight in the above-mentioned strength-enhanced and toughened plastic material compounded with single-chain nanoparticles;
(2) mixing the raw materials uniformly, replacing with a nitrogen gas atmosphere for 30 min, and then polymerizing at 80° C. for 12 h to obtain a reaction product; and
(3) reprecipitating the reaction product in methanol, and then vacuum drying at 70° C. for one week to obtain the strength-enhanced and toughened plastic material compounded with single-chain nanoparticles.

### Comparative Example 1

The plastic material included the following raw materials by weight: ethyl methacrylate (0.13 mol, 15 g), azobisisobutyronitrile (0.026 mmol, 4.27 mg), 4-cyano-4-[(dodecylsulfanylthiocarbonyl)sulfanyl]pentanoic acid (0.13 mmol, 52.5 mg) and 1,4-dioxane (10 mL);

the preparation method of the above-mentioned plastic material specifically included the following steps:
(1) weighing each raw material according to the weight of the above plastic material;
(2) mixing the raw materials uniformly, replacing with a nitrogen gas atmosphere for 30 min, and then polymerizing at 80° C. for 12 h to obtain a reaction product; and
(3) reprecipitating the reaction product in methanol and then vacuum drying at 70° C. for one week to obtain the plastic material.

### Property Testing

The plastic material (PEMA) prepared in Comparative Example 1 and the strength-enhanced and toughened plastic material (PEMA-SCNPs) prepared in Example 1 were taken, and injection-molded to obtain dumbbell-shaped splines respectively, which were then respectively subjected to plastic mechanical property tests and characterization of fracture surface morphology.

### 1. Tensile Property Test

The test was performed on a universal material testing machine (Instron 68TM-5, dual-column, 5 kN) at a room temperature with a tensile speed of 10 mm/min, where the effective tensile area of the dumbbell-shaped spline was of 20 mm×4.0 mm×2.0 mm (ISO 527-2-5A). Each sample was subjected to at least five times of individual tensile tests.

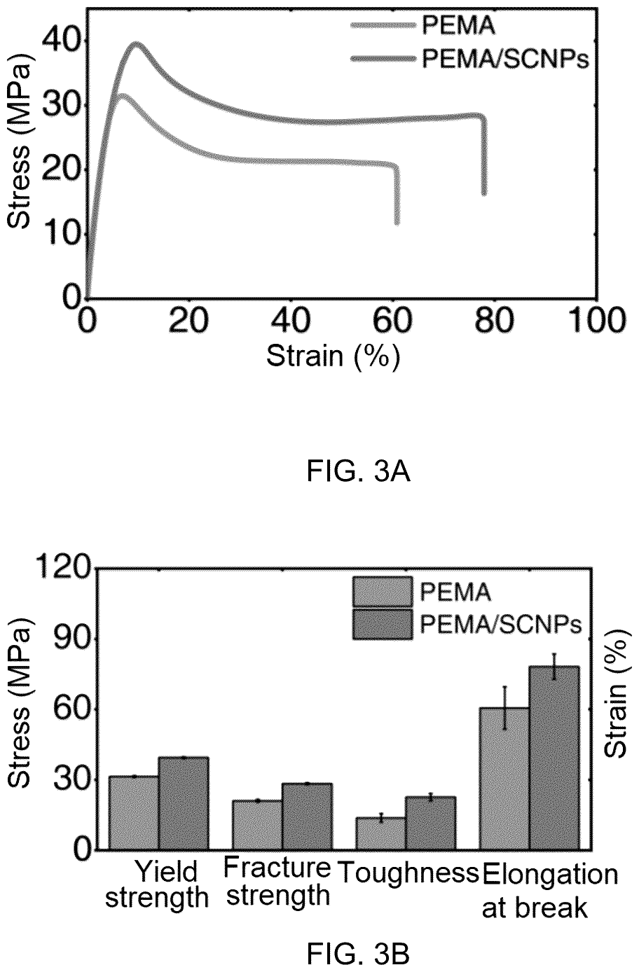

The results are as shown in Table 1 and FIGS. 3A-3B (based on test data of five parallel samples).

TABLE 1
Statistical Data on Tensile Mechanical Properties of
Samples from Comparative Example 1 and Example 1.

| | Yield | Fracture | | Elongation |
|---|---|---|---|---|
| | Strength | Strength | Toughness | at Break |
| Sample | (MPa) | (MPa) | (MPa) | (%) |
| Comparative | 31.42 ± 0.36 | 21.08 ± 0.55 | 13.78 ± 1.81 | 60.60 ± 9.06 |
| Example 1 | | | | |
| Example 1 | 39.45 ± 0.39 | 28.36 ± 0.40 | 22.63 ± 1.52 | 78.20 ± 5.37 |

It can be seen from Table 1 and FIGS. 3A-3B, compared with Comparative Example 1, the yield strength (increased by about 26%), fracture strength, toughness (increased by about two times) and elongation at break of the sample in Example 1 all have been significantly improved, indicating that the present disclosure can simultaneously improve the strength and toughness of the plastic material and achieves synchronous optimization of the “strength-toughness” of the plastic material.

### 2. Three-Point Bending (Flexural Property) Test

The Autograph AG-I 20 kN universal material testing machine manufactured by SHIMADZU Corporation (Japan) was used at a room temperature. The sample preparation and flexural strength calculation were both performed in strict accordance with the national standard GB/T 9341-2000.

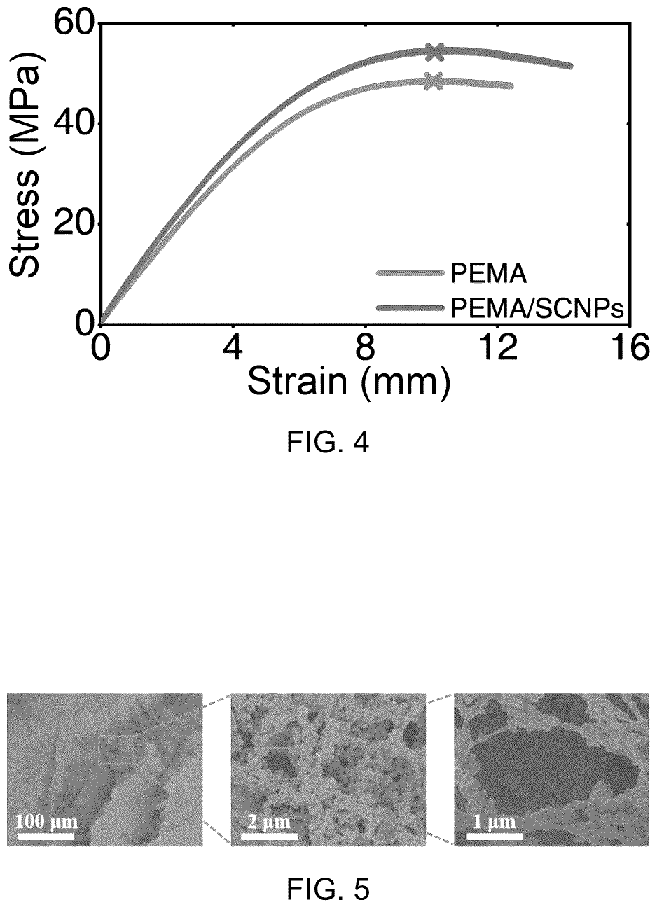

The results are as shown in Table 2 and FIG. 4.

TABLE 2
Statistical Data on Flexural Properties of Samples
from Comparative Example 1 and Example 1.

| Sample | Maximum Flexural Strength (MPa) |
|---|---|
| Comparative | 47.43 ± 0.81 |
| Example 1 | |
| Example 1 | 55.19 ± 1.05 |

As seen from Table 2, compared with Comparative Example 1, the maximum flexural strength of the sample in Example 1 is increased by about 20%, indicating that the present disclosure also improves the flexural property of the plastic material synchronously.

### 3. Characterization of Fracture Surface Morphology

The scanning electron microscopy image of the fracture surface of the sample from Example 1 is as shown in FIG. 5.

As see from FIG. 5, the fracture surface of the sample in Example 1 is uniform and exhibits a network-like structure capable of realizing energy dissipation, showing the characteristics of ductile fracture.

The above description of the disclosed embodiments enables one skilled in the art to implement or use the present disclosure. Various modifications to these embodiments will be apparent to one skilled in the art, and the general principles defined herein may be implemented in other embodiments without departing from the spirit or scope of the present disclosure. Therefore, the present disclosure will not be limited to the embodiments shown herein, but rather will conform to the widest scope consistent with the principles and novel features disclosed herein.

1. A strength-enhanced and toughened plastic material compounded with single-chain nanoparticles, comprising following raw materials in parts by weight: 10-20 parts of a polymer monomer, 0.004-0.005 parts of an initiator, 0.05-0.06 parts of a chain transfer agent, 8-12 parts of a solvent and 0.1-0.2 parts of a functional filler; and
the functional filler is a single-chain nanoparticle with a structural formula of

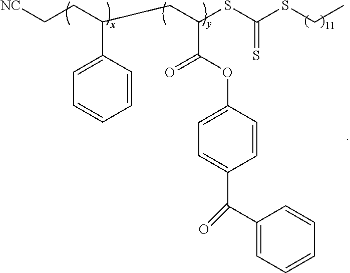

2. The strength-enhanced and toughened plastic material compounded with single-chain nanoparticles according to claim 1, comprising the following raw materials in parts by weight: 15 parts of the polymer monomer, 0.00427 parts of the initiator, 0.0525 parts of the chain transfer agent, 10 parts of the solvent and 0.15 parts of the functional filler.

3. The strength-enhanced and toughened plastic material compounded with single-chain nanoparticles according to claim 1, wherein the polymer monomer is one selected from the group consisting of methyl methacrylate, ethyl methacrylate and styrene.

4. The strength-enhanced and toughened plastic material compounded with single-chain nanoparticles according to claim 1, wherein the initiator is azobisisobutyronitrile.

5. The strength-enhanced and toughened plastic material compounded with single-chain nanoparticles according to claim 1, wherein the chain transfer agent is 4-cyano-4-[(dodecylsulfanylthiocarbonyl)sulfanyl]pentanoic acid.

6. The strength-enhanced and toughened plastic material compounded with single-chain nanoparticles according to claim 1, wherein the solvent is 1,4-dioxane.

7. A preparation method for the strength-enhanced and toughened plastic material compounded with single-chain nanoparticles according to claim 1, comprising the following steps:
(1) weighing the raw materials according to the parts by weight;
(2) mixing the raw materials uniformly, replacing with a nitrogen gas atmosphere, and polymerizing to obtain a reaction product; and
(3) reprecipitating the reaction product in a poor solvent, and vacuum drying to obtain the strength-enhanced and toughened plastic material compounded with single-chain nanoparticles.

8. The preparation method for the strength-enhanced and toughened plastic material compounded with single-chain nanoparticles according to claim 7, wherein in step (2), a time for the replacing is 30 min; and the polymerizing is performed at a temperature of 80° C. for a time of 12 h.

9. The preparation method for the strength-enhanced and toughened plastic material compounded with single-chain nanoparticles according to claim 7, wherein in step (3), the poor solvent is methanol; and the vacuum drying is performed at a temperature of 70° C. for a time of one week.

10. The strength-enhanced and toughened plastic material compounded with single-chain nanoparticles according to claim 2, wherein the polymer monomer is one selected from the group consisting of methyl methacrylate, ethyl methacrylate and styrene.

11. The strength-enhanced and toughened plastic material compounded with single-chain nanoparticles according to claim 2, wherein the initiator is azobisisobutyronitrile.

12. The strength-enhanced and toughened plastic material compounded with single-chain nanoparticles according to claim 2, wherein the chain transfer agent is 4-cyano-4-[(dodecylsulfanylthiocarbonyl)sulfanyl]pentanoic acid.

13. The strength-enhanced and toughened plastic material compounded with single-chain nanoparticles according to claim 2, wherein the solvent is 1,4-dioxane.
